(19) United States
(12) Patent Application Publication
(10) Pub. No.: US 2003/0113078 A1
(43) Pub. Date: Jun. 19, 2003

(54) Methods, systems and means for providing data communications between data equipment

(76) Inventor: Jimmy A. Tatum, Plano, TX (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/016,855

(22) Filed: Dec. 13, 2001

(51) Int. Cl. G02B 6/42; G02B 6/43

(52) U.S. Cl. 385/94; 385/88; 385/89

(57) ABSTRACT

A method and system for the communication of data between data systems and through an optical interface is disclosed. A multi-component optical package (photonic package) and at least one optical fiber are coupled to create an optical data interface, thereby permitting data communications between devices, for example CPUs and display units, through the optical interface. The photonic package thus provides a highly integrated and flexible high bandwidth communications package suitable for data communications. At least one electro-optical data component is mounted on a multi-element leadframe. The photonic components and multi-element leadframe is then overmolded with an encapsulant to create an integrated multi-photonic-device package. The light source may be configured as a plurality of vertical cavity surface emitting lasers (VCSELs) and/or detectors. The light source may be coupled with a plurality of optical fibers to create an optical fiber interface. The plurality of optical components may be configured to form a detector array.

### TECHNICAL FIELD

The present invention is generally related to methods and systems for the optical communication of data between data communications equipment. The present invention is also related to methods and systems for the optical communication of data between data communications equipment such as servers and client, processor and display units, and/or data providers to a plurality of users. The present invention is also related to data communications that requires a large amount of bandwidth for very high-resolution displays. The present invention also relates to high bandwidth communication systems and methods thereof, which utilize a light source, such as a vertical cavity surface emitting laser (VCSEL) or a detector, for the transmission of data. The present invention also generally relates to optical component packaging. The present invention is also generally related to methods and systems of multi-component packaging within a single package.

### BACKGROUND OF THE INVENTION

Communication systems are now being developed in which optical wave guides such as optical fibers are used as conductors for modulated light waves to transmit information. These fibers may be utilized for long distance communication networks, fiber to the home networks, wide area networks, or local area networks.

Such communication networks typically include one or more connectors between the optical wave-guide and a detector or light emitter. A detector converts the signal from the light waves to an electrical signal, which may be used by conventional electrical devices such as a computer. A light emitter, on the other hand, performs the opposite function. It converts an electrical signal into an optical signal. A generic term of either a light emitter or a detector is an “optoelectronic transducer.”

Optical transmission systems have three general components: a light source, the transmission medium, and a detector. Light sources for an optical transmission system are typically either Light Emitting Diodes (LEDs) or lasers. (Semiconductor lasers have distinct advantages over LEDs, including higher data rates and longer distance transmission capabilities.). Typically, a pulse of light from the light source indicates a one bit and the absence of light indicates a zero bit. The transmission medium is commonly ultra-thin glass fiber. The detector generates an electrical pulse when light falls upon it.

Low-cost, high-performance, highly integrated fiber optic interface circuits are becoming increasingly necessary to meet the demands of high-speed digital data communication. With the advent of gigabit Ethernet systems, for example, fiber optic technology has become increasingly preferred. A fiber optic transmission line preferably uses a VCSEL diode as the light source to transmit optical data. In contrast to edge-emitting lasers, VCSELs have a vertical optical cavity that is perpendicular to the epitaxial growth direction. Beams emitting from an edge-emitting laser are highly astigmatic, making them less desirable in high-speed digital data communication applications. VCSELs typically emit a circularly symmetric Gaussian beam, which is very conducive to high-efficiency coupling into optical fiber.

Vertical cavity surface emitting lasers offer numerous performance and potential producibility advantages over conventional edge emitting lasers. These include many benefits associated with their geometry, such as amenability to one- and two-dimensional arrays, wafer-level qualification, and desirable beam characteristics, typically circularly symmetric low-divergence beams.

VCSELs typically have an active region with bulk or one or more quantum well layers. On opposite sides of the active region are mirror stacks, which are typically formed by interleaved semiconductor layers having properties, such that each layer is typically a quarter wavelength thick at the wavelength (in the medium) of interest thereby forming the mirrors for the laser cavity. There are opposite conductivity type regions on opposite sides of the active region, and the laser is typically turned on and off by varying the current through the active region.

High-yield, high performance VCSELs have been demonstrated, and exploited in commercialization. Top-surface-emitting AlGaAs-based VCSELs, for example, are producible in a manner analogous to semiconductor integrated circuits, and are amenable to low-cost high-volume manufacture and integration with existing electronics technology platforms. Moreover, VCSEL uniformity and reproducibility have been demonstrated using a standard, unmodified commercially available metal organic vapor phase epitaxy (MOVPE) chamber and molecular beam epitaxy (MBE) giving very high device yields.

VCSELs can have performance and cost advantages in fast (e.g., Gbits/s) medium distance (e.g., up to approximately 1,000 meters) single or multi-channel data link applications, and numerous optical and/or imaging applications. This results from their inherent geometry, which provides potential low-cost high performance transmitters with flexible and desirable characteristics. Most VCSELs of practical dimensions are inherently multi(transverse) mode. Single lowest-order mode VCSELs are favored for coupling into single-mode fibers and are advantageous for free-space and/or wavelength sensitive systems and may even be beneficial for use in extending standard bandwidth-length multi-mode fibers products.

Data communications from a computer Central Processing Unit (CPU) (i.e., a processor) to a computer monitor (i.e., display unit) typically require a great deal of bandwidth, usually on the order of approximately 1 Gigabyte or more for very high-resolution displays. Electrical cables utilized in accomplishing this task are generally very bulky and expensive to implement. The cost of configuring a system to include such bulky and awkward cables is often greater than the benefit that may be derived through the implementation of communications systems thereof. In particular, electromagnetic radiation issues play a role in determining whether or not to implement such systems, particularly those in which sensitive electronic components are utilized. Based on the foregoing, the present inventor has concluded that these problems can be solved through the design and implementation of a unique communications system, which is based on a new VCSEL packaging scheme. This packaging scheme, including methods and systems thereof, is thus disclosed herein.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide an improved method and system for the optical communication of data.

It is another aspect of the present invention to provide improved methods and system for the optical communication of data between servers and clients, processors and display units, and/or data providers and a plurality of data users.

It is yet another aspect of the present invention to provide a multi-component optical packaging scheme that provides for high bandwidth optical communications.

It is still another aspect of the present invention to integrate a multi-component optical package for coupling with at least one optical fiber to create a communications interface, which permits data to be communicated between data systems.

It is another aspect of the present invention to provide an optical interface created through the integration of at least one vertical cavity surface emitting laser (VCSEL) and/or at least one detector chip to form an optical communications array. It is also an aspect of the present invention to provide for bidirectional communication with such an interface through the integration of VCSELs and detectors within a single optical package.

The above and other aspects can be achieved as is now described. A method and system for the communication of data between, for example, a display unit and a processor through an optical fiber interface is disclosed herein. A light source and at least one optical fiber can be coupled to create an optical fiber interface, thereby permitting data communications between the processor and any display unit through the optical fiber interface. The optical fiber interface created thus can provide a highly integrated and flexible high bandwidth communications package suitable for display data communications. The light source is generally mounted on a multi-element leadframe. The light source and multi-element leadframe can then be overmolded with plastic to create the optical fiber interface. The light source may be configured as more than one vertical cavity surface emitting laser (VCSEL) and/or detector. The light source may be coupled with a plurality of optical fibers to create the optical fiber interface. The plurality of optical fibers may be configured to form a detector array. Additionally, the optical fibers utilized may be ribbon plastic optical fibers. The display unit itself may be at least one monitor or display screen, such as a digital television screen, and the process may be a CPU.

The present invention thus discloses methods and systems that can be utilized to implement a packaging scheme that provides for a high bandwidth communication system utilizing plastic optical fiber, which is flexible, light and possesses a very high bandwidth. Packaging occurs through the integration of a light source, such as more than one VCSEL, and a detector array suitable for high bandwidth data transmissions. VCSELs or detector chips may be mounted on a multi-element leadframe and overmolded with plastic to create the optical fiber interface. Alignment tolerances are generally minimal because the fiber core diameter can be chosen to be approximately 500 microns to 1 mm.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 illustrates a light source and/or detector package capable of interfacing with, for example, more than one optical fiber, a package, which may be implemented in accordance with a preferred embodiment of the present invention;

FIG. 2 depicts a block diagram of a system for communicating data, which may be implemented in accordance with a preferred embodiment of the present invention;

FIG. 3 illustrates a block diagram of a media system configuration, in accordance with a preferred embodiment of the present invention;

FIG. 4 depicts an optical component package having an optical fiber interface with edges, notches and/or holes for alignment with other components or optical fibers, in accordance with a preferred embodiment of the present invention;

FIG. 5 illustrates a block diagram of a Tₓ/Rₓ configuration, in accordance with a preferred embodiment of the present invention; and

FIG. 6 depicts a block diagram generally illustrating an example channel configuration, which may be implemented in accordance with a preferred embodiment of the present invention.

### DETAILED DESCRIPTION OF THE INVENTION

The particular values and configurations discussed in these non-limiting examples can be varied and are cited merely to illustrate an embodiment of the present invention and are not intended to limit the scope of the invention.

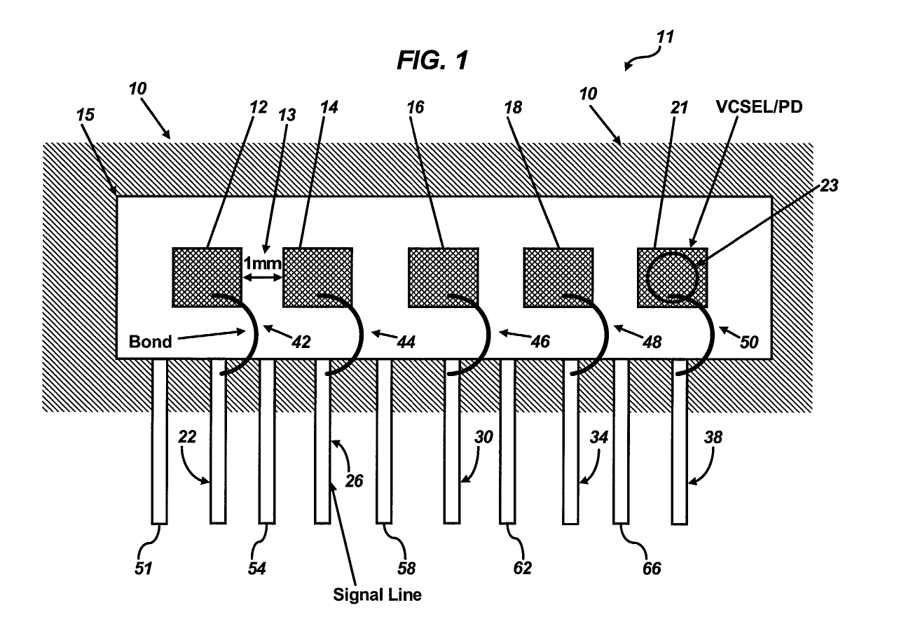

FIG. 1 illustrates an optical component package and/or interface 11 implemented in accordance with a preferred embodiment of the present invention. Optical interface 11 includes an encapsulant 10, which is overmolded above one or more electro-optical components (e.g., laser light sources or light detectors) 12, 14, 16, 18, and 21, which can be configured as a combination of VCSELs or photodetectors. A plurality of signal lines 22, 26, 30, 34 and 38 are also included within encapsulant 10 and can be configured such that each signal line includes dedicated grounds. A VCSEL, for example, generally requires one connection to the anode and another for the cathode. Thus, as depicted in FIG. 1, signal lines 22, 26, 30, 34 and 38 are respectively associated with grounds 51, 54, 58, 62, and 66. It should be appreciated by those skilled in the art that a single, common ground could take the place of grounds 51-66 in applications where signal interference associated with a common ground are not a concern within a common package such as encapsulant 10. Bonds can connect the individual light sources to particular signal lines. Thus, light source 12 can be connected by bond 42 to signal line 22. Light source 14 is generally connected by bond 44 to signal line 26. Light source 16 is generally linked by bond 46 to signal line 30, while light source 18 can be linked to signal line 34 by bond 48. Finally light source 21 can be connected by bond 50 to signal line 38.

Although FIG. 1 illustrates five electro-optical components 12, 14, 16, 18 and 21 found within the encapsulant 10, those skilled in the art can appreciate that fewer than or more than five such components can be implemented in accordance with alternative embodiments of the present invention. Five components are depicted in FIG. 1 for illustrative purposes only. The number of such components (e.g., VCSEL, photodetector, etc.) is not a limiting feature of the present invention. A similar arrangement holds true for the number of signal lines that can be implemented in accordance with the present invention. Ten signal lines, 22, 26, 30, 34 38, 51, 54, 58, 62, and 66, are indicated in FIG. 1. Fewer or more than ten such signal lines, however, can be implemented in accordance with the present invention. The ten signal lines are thus shown for illustrative purposes only.

FIG. 1 thus illustrates a packaging scheme in which individual optical components, such as VCSELs or detector chips, can be mounted on a multi-element leadframe 15 and overmolded with, for example, plastic as a encapsulant 10 to create fiber optic interface 11. Encapsulant 10 can, for example, be composed of plastic and function as an overmolding feature. Alignment tolerances are generally minimal because the fiber core diameter is generally in the approximate range of 500 microns to 1 mm as indicated by reference numeral 13. Note that although 1 mm is described in FIG. 1 via reference numeral 13, this value is simply presented for illustrative purposes only. Also, it should be appreciated that a combination of components can be encapsulated within a single package, such as a two component package having one VCSEL and one detector in order to provide transmit and receive capabilities within a single package/interface.

Optical hardware (e.g., lenses, optical scattering surfaces and optical concentrators) can also be incorporated within the package encapsulant 10. As shown in FIG. 1, optical hardware in the form of a lens 23 is placed over the photonic device 21. The lens can provide signal conditioning upon transmission or receipt, to or from a fiber. The optical hardware is optional and can be incorporated into a customized package according to desired signal conditioning specifications.

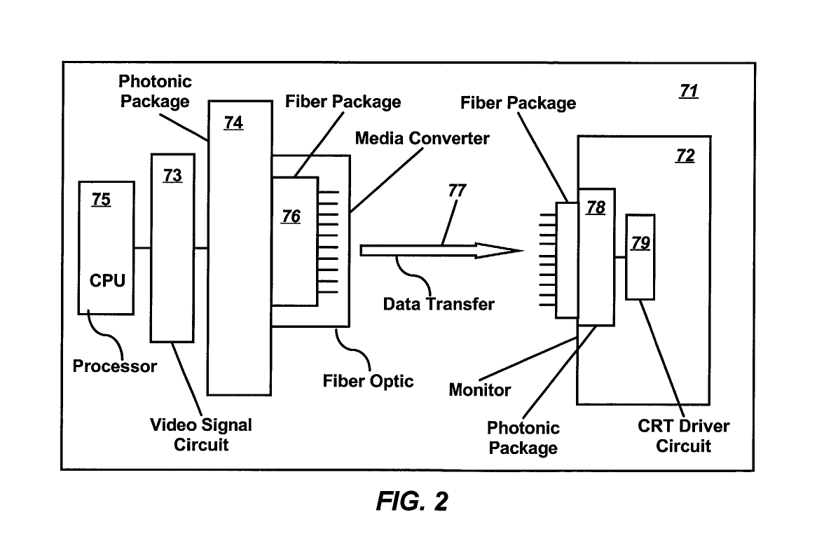

FIG. 2 depicts a block diagram of a system 71 for the communication of display data, which can be implemented in accordance with a preferred embodiment of the present invention. Although display data is described, it should be appreciated that the invention can be utilized in several data communications schemes (e.g., intranet or Internet connectivity, peripheral connectivity, etc.) and, therefore, the following description regarding display data is provided for exemplary purposes. The electro-optical (photonic) package system 71 described in FIG. 2 and FIG. 1 can utilized more generally for any data output port.

Photonic package system 71 permits data communications between a CPU 75 and a monitor 72 through an optical fiber interface, such as optical fiber interface 11 of FIG. 1. Such an interface can provide a highly integrated and flexible high bandwidth communications package suitable for display data communications. As illustrated in FIG. 2, a fiber optic cable can be linked to CPU 75. A photonic package 74 can thus be coupled between video signal circuit 73 associated with CPU 75, and a fiber optic cable interface 76, which provides for alignment/placement of receiving ends of fibers in front of the active photonic components of the photonic package 74. The fiber optic cable 77 can be provided in the form of ribbon cable. The fiber optic cable 77 transmits/receives signals from the photonic package 74 toward a receiving photonic package 78, which then permits optical signals representing display data to be converted by monitor-based video driver circuitry 79 for display at monitor 72. Note that as utilized herein, the term “processor” can refer to a processing device, such as CPU 75 and the term “display unit” can refer to a display unit, such as monitor 72. Note that although the term “display data” is utilized herein to refer to data which may be displayed on a display unit, such as monitor 72, the term “display data” may also refer to other types of data, such as, for example, audio data, streaming video and audio, large text files and/or so forth. A CPU is generally a computational and control unit of a computer and functions as the device that interprets and executes instructions. Such a CPU can be a microprocessor or an integrated system that combines both a processor and computer memory or even a computer console to perform particular functions based on specific instructions.

Based on the configuration illustrated in FIG. 2, it can thus be appreciated that system 71 provides a much more efficient arrangement for communicating data, such as display data between CPU 75 and monitor 72, than utilizing electrical cables, which can be bulky and costly. A photonic package 74 thus reduces the need for awkward and expensive electrical cabling arrangements.

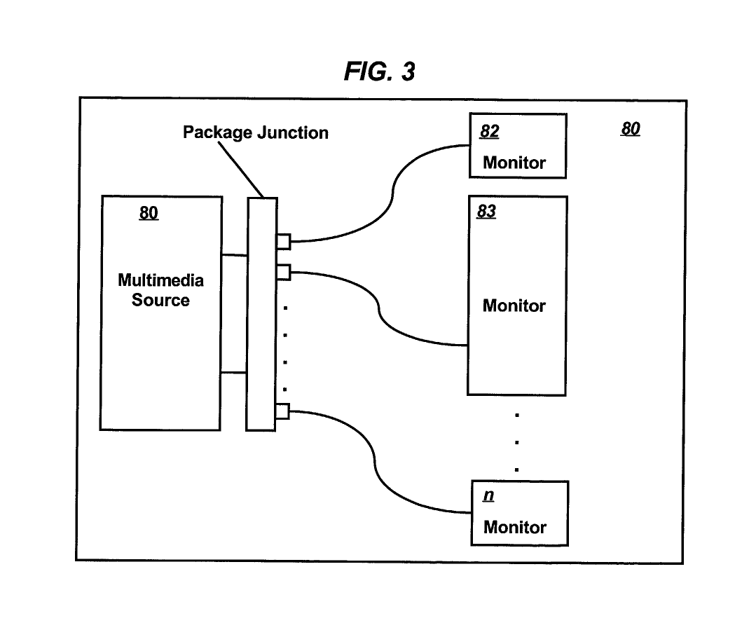

A system such as that described in FIG. 2, can, for example, be expanded for the purpose of providing an entertainment system arrangement to users in a confined area, such as within an airplane cabin. Referring to FIG. 3, a multimedia system 80 can be utilized to transfer display data (e.g., movies, entertainment data, etc.) to a plurality of display units or monitors 82-n, which are positioned throughout the airplane cabin. Remote monitors can be connected to the multimedia source 80 via a photonic junction box 81, or a plurality of photonic junction boxes, which can contain photonic packages 11 of the present invention. Such a configuration is particularly useful in configurations in which electromagnetic radiation (EMI) issues are particularly important. By avoiding bulky electrical cables and utilizing instead a packaging scheme involving VCSELs mounted on a leadframe using ribbon plastic optical fibers, both bulk and EMI issues can be greatly reduced.

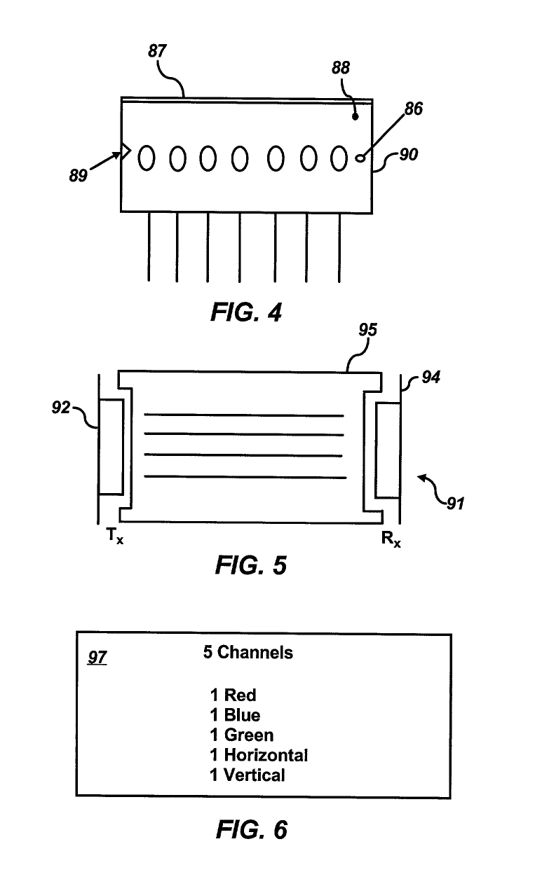

FIG. 4 depicts a photonic package 90 in accordance with the teaching of the present invention and means to align the package 90 with fiber optics. As shown in FIG. 4, pins 86, edges 87, holes 88 and/or notches 89 can be useful for aligning and successfully coupling a photonic package with a fiber optic cable package (e.g., fiber optic ribbon cable). Note that the photonic package 90 is analogous to eletro-optic package 11 of FIG. 1. Photonic package 90 is described in FIG. 4 to emphasize the fact that alignment tolerance are minimal due to the particular spacing of light sources (e.g., VCSELs, photodetectors, etc.) within the package. Therefore, a fiber optic interface should be able to properly align with the active components of the package 90. Any combination, or individual use, of pins 86, holes 88, notches 89 and/or edges 87 can be useful and, thus, particularly important for interface/alignment purposes.

FIG. 5 illustrates a block diagram of a Tₓ/Rₓ configuration 91, in accordance with a preferred embodiment of the present invention. FIG. 5 is presented to simply illustrate a complete system interface. Optical package 92 is shown interfaced with optical fibers 95 on a first end (initiating end), and then the optical fibers are again interfaced and on a second end (terminating end) with another optical package 94. The optical fiber 95 can be a ribbon fiber optic cable.

FIG. 6 depicts a block diagram 97 generally illustrating an example of channel configurations, which can be implemented in accordance with a preferred embodiment of the present invention. As depicted in FIG. 6, five channels (Red, Blue, Green, Horizontal, and Vertical) can be provided wherein each channel is associated with a particular optical communication source (e.g., VCSEL). Thus, for example, a red channel is may be associated with light source 12 of FIG. 1, while a blue channel may be associated with channel 14 of FIG. 1 and so forth. Each channel is capable of communicating data. Data from each channel can be communicated simultaneously with other channels, thus expanding interface bandwidth. It should be appreciated that this is just an example of the types of “dedicated” signaling that can be provided through an optical package described herein.

FIGS. 1 to 6 herein thus generally illustrate systems and devices for the optical communication of data between data communication equipment. For example, a display unit and a processor can communicate through the present optical interface. Any display unit can be provided in the form of a personal monitor or larger display screen, such as a digital television screen, and any processor may be provided in the form of a CPU typically found within a personal computer or server. A plurality of photonic devices commonly bound within a package and at least one optical fiber can also be coupled to create an optical data interface, thereby permitting data communications between the processor/server/data provider and a corresponding client/data user/display unit through the optical interface when used in combination with other optical communication equipment (e.g., fibers, routers, switches, MUX/DEMUX, etc.). Thus, the optical interface/package created thus can provide a highly integrated and flexible high bandwidth communications package suitable for data communications. The photonic component (e.g., VCSEL, photodetector, etc.) is generally mounted on a multi-element leadframe.

The present invention thus discloses a method and system that can be utilized to implement a multi-component packaging scheme that provides for a high bandwidth communication system usable with, for example, plastic optical fibers, which are flexible, light and possess a very high bandwidth. Packaging occurs through the integration of photonic devices, such as a VCSEL and/or detector array suitable for full-duplex, high bandwidth data transmissions. Individual VCSEL or detector chips may be mounted on a multi-element leadframe. The photonic devices and multi-element leadframe can then be overmolded with plastic to create the optical fiber interface. Additional optical hardware, such as lenses, diffractors and/or concentrators, can incorporated within the package. The package can be coupled with a plurality of optical fibers to create an optical data communication interface. The plurality of optical fibers may be configured to form a data transmission array. Additionally, the optical fibers utilized may be ribbon plastic or glass optical fibers. Alignment tolerances are generally minimal because the fiber core diameter can be chosen to be approximately 500 microns to 1 mm. Alignment can be accomplished from molded package geometry (e.g., package shape, integrated holes/notches/pins formed on/in/around the packaging, etc.).

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the spirit and scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. A method for the communication of data, said method comprising the steps of:
integrating at least two optical components into a photonic package that can coupled with communications equipment; and
permitting data communications between communications equipment through said optical interface, such that said optical interface provides a highly integrated and flexible high bandwidth communications package suitable for data communications.

2. The method of claim 1 further comprising the step of:
communicating data between a central processing unit (CPU) and at least one display unit through said photonic package.

3. The method of claim 1 wherein the step of integrating at least two optical components into a photonic package, further comprises the steps of:
mounting at least two photonic components on a multi-element leadframe; and
overmolding said at least two photonic components and said multi-element leadframe with an encapsulant.

4. The method of claim 4 wherein said at least two optical components comprise at least one vertical cavity surface emitting laser (VCSEL).

5. The method of claim 4 wherein said at least two optical components comprise at least one photodetector.

6. The method of claim 1 further comprising the step of:
5 coupling said photonic package to a plurality of optical fibers to create said optical interface.

7. The method of claim 5 wherein said plurality of optical fibers comprises a fiber optic ribbon cable.

8. The method of claim 7 further comprising the step of:
maintaining alignment tolerances between said at least two optical components of said package and said optical fibers having fiber core diameters between approximately 500 microns and 1 mm by utilizing alignment means integrated within said package.

9. The method of claim 1 wherein said communication is between a multimedia source and at least one video data display.

10. A method for the communication of data between a Central Processing Unit (CPU) and a display monitor through a photonic package and fiber optic interface, said method comprising the steps of:
coupling a photonic package containing at least two vertical cavity surface emitting lasers (VCSELs) with at least one ribbon plastic optical fiber to create an optical data interface; and
permitting data communications between said CPU and said display monitor through an optical data interface, such that said optical data interface provides a highly integrated and flexible high bandwidth communications package suitable for display data communications.

11. A method for the communication of data between a server and at least one client through an optical interface, said method comprising the steps of:
creating an optical interface by coupling at least two photonic devices integrated into a common optical package residing with said server with fiber optic cable; and
permitting data communications between said server and said at least one client through said optical interface, such that said optical interface provides a highly integrated and flexible high bandwidth communications package suitable for data communications.

12. A system for communicating data between a CPU and a display unit through an optical fiber interface, said system comprising:
a first optical component package of at least two integrated optical components electrically connected with a CPU;
a second optical component package of at least two integrated optical components electrically connected to a display unit; and
at least one optical fiber connecting said first optical component package and said second optical component package.

13. The system of claim 12 further comprising:
said at least one optical fiber is a ribbon cable further comprising more than one optical fiber.

14. A common optical communication component package 11, comprising:
more than one photonic components mounted on a multi-element leadframe; and
plastic overmolding covering said more than one photonic components and said multi-element leadframe to create said optical interface.

15. The system of claim 12 wherein said more than one optical components comprises at least one vertical cavity surface emitting laser (VCSEL).

16. The system of claim 12 wherein said more than one optical components comprises at least one photodetector.

17. The system of claim 12 wherein said more than one optical component includes optical hardware.

18. The system of claim 17 wherein said optical hardware includes at least one lens.

19. The system of claim 12 further including alignment means integrated with said package, wherein alignment tolerances associated with said package to a plurality of optical fibers is maintained via alignment means between said package and fiber optic interface associated with said optical fibers.

20. The system of claim 17 wherein said optical hardware includes fiber optic alignment means.

21. A system for communicating data between a server and at least one client through an optical fiber interface, said system comprising:
at least two photonic devices integrated within a common package coupled with at least one ribbon plastic optical fiber system to create an optical fiber interface, wherein data communications are permitted between said server and at least one client through said optical fiber interface, such that said optical fiber interface provides a highly integrated and flexible high bandwidth communications package suitable for display data communications.

22. A system for communicating data between data systems through an optical fiber interface, said system comprising:
a photonic package comprising at least one electro-optical devices integrated within a common component package that can be coupled with at least one ribbon plastic optical fiber, said package created by said devices on a multi-element leadframe and overmolding said electro-optical devices and said multi-element leadframe with an encapsulant to create a photonic package suitable for coupling to a fiber optic cable.
